(19) United States
(12) Patent Application Publication
(10) Pub. No.: US 2017/0178130 A1
(43) Pub. Date: Jun. 22, 2017

(54) METHOD AND SYSTEM FOR ACCOUNT CONTROL BASED ON DECLINED AUTHORIZATION

(71) Applicant: MasterCard International Incorporated, Purchase, NY (US)

(72) Inventor: Gregory COBURN, Dublin 9 (IE)

(73) Assignee: MasterCard International Incorporated, Purchase, NY (US)

(21) Appl. No.: 14/974,416

(22) Filed: Dec. 18, 2015

(51) Int. Cl. G06Q 20/40; G06Q 20/42

(52) U.S. Cl. CPC G06Q 20/405; G06Q 20/42

(57) ABSTRACT

A method for automatic generation of transaction controls includes: storing account profiles, each including a primary account number, communication data, and transaction controls, where payment transactions are subject to the transaction controls; receiving a transaction message for a declined payment transaction including a specific primary account number and additional data elements configured to store transaction data; identifying a specific account profile that includes the specific primary account number; generating a transaction control including one or more controls based on the transaction data; transmitting the generated transaction control to a computing device based on the communication data included in the specific account profile; receiving a confirmation from the computing device indicating approval of the generated transaction control; and updating the specific account profile to include the generated transaction control.

### FIELD

The present disclosure relates to the automatic generation of account controls, specifically the automatic generation of transaction controls for a transaction account based on data values stored in a transaction message for a declined transaction, and in particular a transaction declined due to previously established transaction controls.

### BACKGROUND

As technology gets stronger and more developed, people are more accustomed to having control of various aspects of their daily lives. Greater control can provide for greater security, peace of mind, and other benefits both tangible and intangible. One such aspect that individuals have begun to experience greater control has been the use of their transaction accounts, and in particular credit card accounts, when conducting financial transactions. Controls on the usage of a transaction account when conducting a financial transaction, referred to herein as “transaction controls,” can provide individuals with peace of mind and a heightened level of security on their account, as it enables them to greatly limit usage of their account, which can prevent fraudulent transactions as well as provide significant benefits to those that share their account with others, such as a parent with their children or an employer with their employees.

Many platforms that enable an individual to set transaction controls rely on the individual to create and establish the controls themselves. However, many account holders are often unfamiliar with their own transaction habits and may over- or underestimate their amount of spending, their spending at various merchants or with various merchant industries, their transaction frequency, etc. In such cases, it may take a significant amount of time for an individual to establish transaction controls that are both effective and yet not overly restrictive. In the meantime, the account may be exposed to fraud, the individual may be restricted from conducting desired transactions, other users of the account may freely transact when they should otherwise be restricted, etc.

Thus, there is a need for a technical solution where transaction controls can be establish for a transaction account quickly and efficiently, with minimal participation by the account holder. In addition, there is a need for a technical solution where the development of transaction controls is designed to initially restrict transactions to provide for greater account protection. The use of a technological solution that greatly improves creation time for new, effective transaction controls may minimize inconvenience for users of the account, while maximizing the security provided to the account via use of the transaction controls.

### SUMMARY

The present disclosure provides a description of systems and methods for automatic generation of transaction controls.

A method for automatic generation of transaction controls includes: storing, in an account database of a processing server, a plurality of account profiles, wherein each account profile includes a standardized data set related to a transaction account including at least a primary account number, communication data, and one or more transaction controls, where use of the related transaction account in funding a payment transaction is subject to the one or more transaction controls; receiving, by a receiving device of the processing server, a transaction message for a payment transaction, wherein the transaction message is formatted based on one or more standards and includes a plurality of data elements including at least a first data element configured to store a response code indicative of a declined transaction, a second data element configured to store a specific primary account number, and one or more additional data elements configured to store transaction data; executing, by a querying module of the processing server, a query on the account database to identify a specific account profile where the included primary account number corresponds to the specific primary account number stored in the second data element included in the received transaction message; generating, by a control processing module of the processing server, a transaction control, wherein the transaction control includes one or more controls based on transaction data stored in at least one of the one or more additional data elements included in the received transaction message; electronically transmitting, by a transmitting device of the processing server, a data signal superimposed with the generated transaction control to a computing device associated with the transaction account related to the identified specific account profile based on the included communication data; receiving, by the receiving device of the processing server, a data signal electronically transmitted the computing device, wherein the data signal is superimposed with a confirmation indicating approval of the generated transaction control; and updating, in the account database, the specific account profile to include the generated transaction control.

A system for automatic generation of transaction controls includes: an account database of a processing server configured to store a plurality of account profiles, wherein each account profile includes a standardized data set related to a transaction account including at least a primary account number, communication data, and one or more transaction controls, where use of the related transaction account in funding a payment transaction is subject to the one or more transaction controls; a receiving device of the processing server configured to receive a transaction message for a payment transaction, wherein the transaction message is formatted based on one or more standards and includes a plurality of data elements including at least a first data element configured to store a response code indicative of a declined transaction, a second data element configured to store a specific primary account number, and one or more additional data elements configured to store transaction data; a querying module of the processing server configured to execute a query on the account database to identify a specific account profile where the included primary account number corresponds to the specific primary account number stored in the second data element included in the received transaction message; a control processing module of the processing server configured to generate a transaction control, wherein the transaction control includes one or more controls based on transaction data stored in at least one of the one or more additional data elements included in the received transaction message; and a transmitting device of the processing server configured to electronically transmit a data signal superimposed with the generated transaction control to a computing device associated with the transaction account related to the identified specific account profile based on the included communication data. The receiving device of the processing server is further configured to receive a data signal electronically transmitted the computing device, wherein the data signal is superimposed with a confirmation indicating approval of the generated transaction control. The processing server is further configured to update, in the account database, the specific account profile to include the generated transaction control.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the automatic generation of transaction controls based on declined payment transactions in accordance with exemplary embodiments.

FIG. 2 is a block diagram illustrating the processing server of FIG. 1 for the automatic generation of transaction controls based on declined payment transactions in accordance with exemplary embodiments.

FIG. 3 is a flow diagram illustrating a process for the automatic generation of transaction controls based on declined payment transactions using the system of FIG. 1 in accordance with exemplary embodiments.

FIG. 4 is a diagram illustrating a graphical user interface for the selection of transaction controls automatically generated by the processing server of FIG. 2 for a declined payment transaction in accordance with exemplary embodiments.

FIG. 5 is a flow chart illustrating an exemplary method for automatic generation of transaction controls in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Payment Card—A card or data associated with a transaction account that may be provided to a merchant in order to fund a financial transaction via the associated transaction account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated transaction account (e.g., as stored in a communication device, such as a smart phone or computer). For example, in some instances, data including a payment account number may be considered a payment card for the processing of a transaction funded by the associated transaction account. In some instances, a check may be considered a payment card where applicable.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Automatic Generation of Transaction Controls

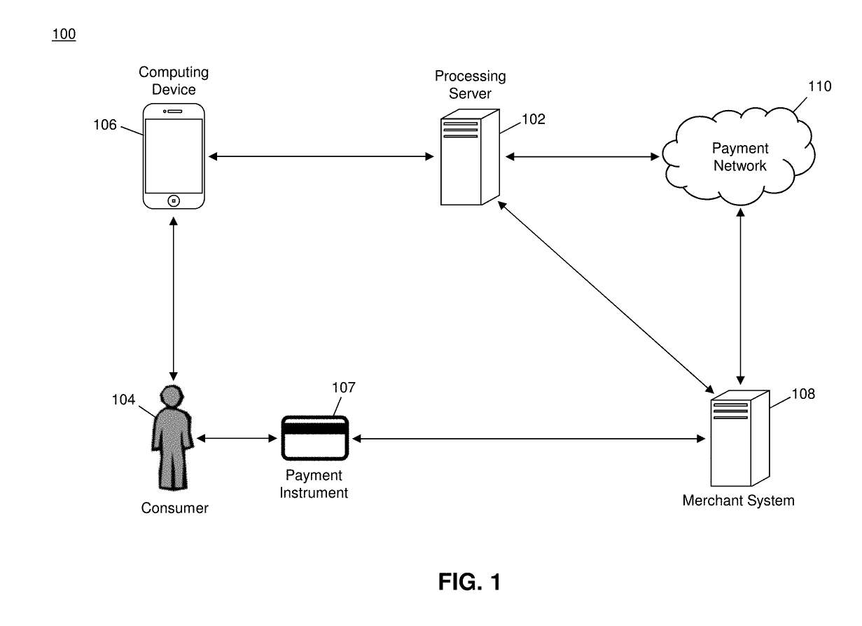

FIG. 1 illustrates a system 100 for the automatic generation of transaction controls for a transaction account based on data values parsed from a transaction message for a declined payment transaction.

The system 100 may include a processing server 102. The processing server 102, discussed in more detail below, may be configured to automatically generate transaction controls for a transaction account based on declined payment transactions. In the system 100, a consumer 104 may register with the processing server 102 for the automatic generation of transaction controls for their transaction account. The consumer 104 may use a computing device 106 to register. The computing device 106 may be any type of computing device suitable for performing the functions discussed herein, such as a desktop computer, laptop computer, notebook computer, tablet computer, cellular phone, smart phone, smart television, smart watch, wearable computing device, implantable computing device, etc.

As part of the registration process, the consumer 104 may use the computing device 106 to electronically transmit transaction account data to the processing server 102. The transaction account data may be data associated with a transaction account for which the consumer 104 desires the automatic generation of account controls. The transaction account data may include, for example, a primary account number associated with the transaction account. In some instances, the transaction account data may also include authentication information, such as may be used by the processing server 102 in verifying that the consumer 104 is authorized to control, manage, use, or otherwise affect change to the transaction account. Authentication information may include, for example, a username, password, personal identification number, etc. In such instances, the processing server 102 may contact an issuing financial institution, such as an issuing bank, for authentication of the consumer 104 using the authentication information prior to registering the transaction account.

The registration information may also include contact information. The contact information may include data suitable for use by the processing server 102 to contact the consumer 104 regarding automatically generated transaction controls. The contact information may include, for example, a communication method, network, and/or protocol and a communication address. For instance, the consumer 104 may specify the short messaging service (SMS) as the communication method and a telephone number associated with the computing device 106 as the communication address. In such an instance, future communications by the processing server 102 may be sent by SMS to the computing device 106. Other communication methods may include, for example, e-mail, telephone, application program, webpage, etc., with communication addresses including, for example, e-mail address, username, telephone number, internet protocol address, media access control address, serial number, registration number, identification number, etc.

The processing server 102 may generate an account profile, discussed in more detail below, for the transaction account. In an exemplary embodiment, the processing server 102 may generate one or more transaction controls configured to decline all payment transactions where the transaction account is identified as the funding source for the transaction. In such an embodiment, all transactions may be declined such that the subsequent automatically generated transaction controls may be used to ensure that transaction controls are specifically tailored to only those transactions conducted by the consumer 104. In some embodiments, the processing server 102 may generate or otherwise identify a controlled payment number, which may be distributed to the consumer 104 (e.g., using the computing device 106 or other method indicated in the contact information), for use in place of their registered primary account number. In other embodiments, the registered primary account number may be an established controlled payment number. As discussed herein, any account number used in an electronic payment transaction that is subject to controls may thereby be considered a controlled payment number.

To start the process of automatically generating transaction controls, the consumer 104 may present a payment instrument 107 to a merchant system 108 as part of the conducting of an electronic payment transaction. The payment instrument 107 may be any suitable type of payment instrument that is used to convey payment details to the merchant system 108, such as a payment card, check, virtual card (e.g., stored in the computing device 106), etc. Payment details may be conveyed via any suitable method, including near field communication, radio frequency, machine-readable code, magnetic strip, integrated circuit, etc. Payment details may include at least a transaction account number corresponding to the associated transaction account. Additional data including payment details, such as payment cryptograms, will be apparent to persons having skill in the relevant art. The payment instrument 107 used by the consumer 104 may be associated with the same transaction account registered with the processing server 102 by the consumer 104.

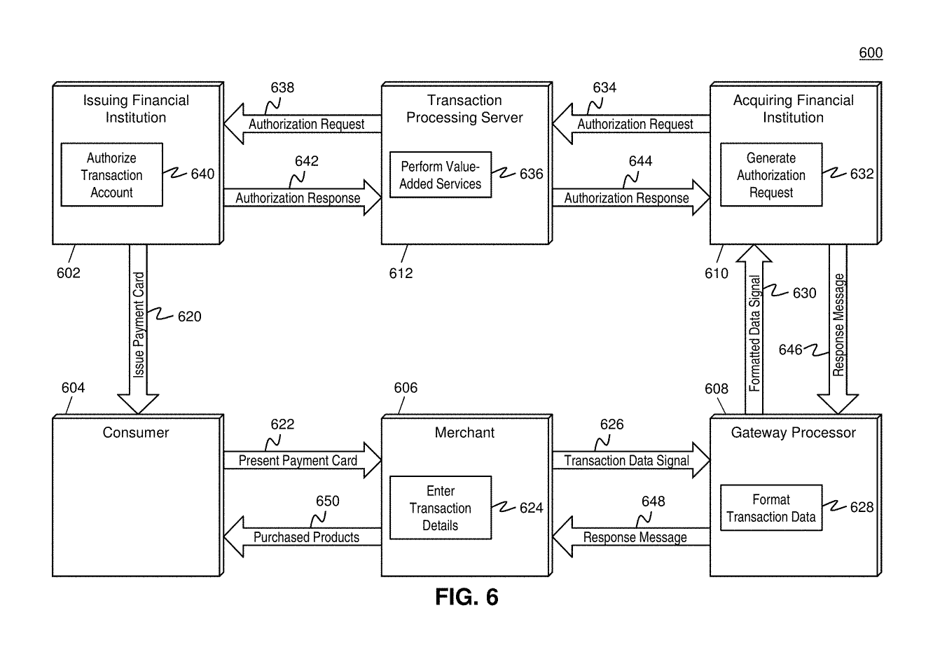

The merchant system 108 may receive the payment details from the payment instrument 107. The merchant system 108 may be a point of sale system or other suitable type of computing system configured to perform the traditional functions of an electronic payment transaction for a merchant. The merchant system 108 may store transaction data for the electronic payment transaction. Transaction data may include, for example, a transaction amount, transaction time, transaction date, geographic location, product data, offer data, reward data, loyalty data, merchant data, point of sale data, and other data that may be used in the processing of an electronic payment transaction. The merchant system 108 may electronically transmit the transaction data and payment details for use in the processing of the payment transaction. The transaction data and payment details may be transmitted to an acquiring financial institution, such as an acquiring bank, and/or one or more intermediate entities (e.g., a gateway processor). The transaction data and payment details may be included in a transaction message that is forwarded to a payment network 110 via the payment rails. Additional detail regarding the submission of transaction data to a payment network 110 for processing is discussed in more detail below with respect to the process 600 illustrated in FIG. 6.

The payment network 110 may receive the transaction message for the payment transaction via the payment rails. The transaction message may be a specially formatted data message that is formatted pursuant to one or more standards governing the exchange of financial transaction messages, such as the International Organization of Standardization's ISO 8583 standard. Transaction messages may include a plurality of data elements, where each data element may be configured to store payment and transaction data as set forth in the associated standards, such as a data element configured to store a primary account number, a data element configured to store a transaction amount, a data element configured to store a transaction time, etc. Transaction messages may also include a message type indicator, which may be indicative of a type of the transaction message, such as an authorization request, authorization response, etc. In some instances, a transaction message may also include a bitmap, which may indicate the data elements included in the transaction message and the data stored therein.

The transaction message for the electronic payment transaction involving the merchant system 108 and consumer 104 may include at least a first data element configured to store the controlled payment number provided by the payment instrument 107 and one or more additional data elements configured to store additional transaction data. In some embodiments, the transaction message may be electronically transmitted to the payment network 110, which may forward the transaction message to the processing server 102 via the payment rails. In other embodiments, the transaction message may be directly transmitted to the processing server 102 from the merchant system 108 (e.g., via the acquirer and/or other intermediate entity), and may be transmitted using the payment rails or a suitable alternative communication method. In instances where the payment network 110 may receive the transaction message first, the payment network 110 may be configured to forward the transaction message to the processing server 102 based on the primary account number stored in the corresponding data element. For example, the primary account number may be a controlled payment number that includes a bank identification number within a range associated with the processing server 102, which may be used by the payment network 110 in the routing of received transaction messages.

The processing server 102 may receive the transaction message, and may determine if the related payment transaction is to be declined based on the transaction controls set for the transaction account. The processing server 102 may identify the transaction account used in the payment transaction based on the primary account number stored in the corresponding data element included in the transaction message. The processing server 102 may then determine if the transaction is to be declined based on the transaction controls set for the transaction account and the transaction data stored in the additional data elements included in the transaction message. In embodiments where initial transaction controls set for a newly registered transaction account are established to decline all payment transactions, the processing server 102 may decline the first payment transaction attempted. If the payment transaction is not declined (e.g., all transaction controls are satisfied), then the processing server 102 may forward the transaction message to the payment network 110, which may be accompanied with or include an indication that the transaction is not declined, or may not include any indication that the transaction is declined.

If the payment transaction is declined (e.g., one or more transaction controls are not satisfied), then the processing server 102 may return a response message to the payment network 110 that includes a response code in a second data element that indicates that the transaction is declined. In some instances, the response message may be a new transaction message generated by the processing server 102. In other instances, the response message may be a modification of the received transaction message. The response message may include the response code in the second data element, and may also include a message type indicator indicative of an authorization response. In some instances, the response code may indicate that the transaction was declined due to transaction controls. The payment network 110 may then forward the authorization response to an acquiring financial institution or other entity associated with the merchant system 108, which may inform the merchant system 108 of the decline. The merchant system 108 may then inform the consumer 104 of the decline, and perform any additional functions associated with a declined payment transaction. Methods and functions performed in conjunction with a declined payment transaction will be apparent to persons having skill in the relevant art.

Once a transaction has been declined, the processing server 102 may automatically generate one or more transaction controls based thereon. The transaction controls may be generated based on the transaction data stored in the one or more additional data elements included in the received transaction message. In some instances, the processing server 102 may generate separate transaction controls for each of the data values stored in the additional data elements. In other instances, the processing server 102 may generate a single transaction control that incorporates the data values stored in a plurality of the additional data elements. In yet other instances, the processing server 102 may generate multiple transaction controls for various combinations of data values.

For example, the additional data elements may include data elements configured to store a transaction amount, a transaction time, a transaction date, a merchant name, a merchant identifier, a merchant category code, and a geographic location. The processing server 102 may generate a transaction control that allows payment transactions at or below the transaction amount that are with the same merchant at the same geographic location, as well as a transaction control that allows payment transactions at that merchant around the same time of day (e.g., within an hour of the transaction time), and a transaction control that allows payment transactions at or below the same transaction amount on the same day of the week. Transaction controls may be automatically generated by the processing server 102 to prohibit or enable transactions based on any suitable aspect of the transaction, as well as based on multiple transactions, such as transaction frequency (e.g., number of transactions during a predetermined period of time, such as daily), aggregate spending amount, total number of transactions, etc. In some instances, transaction controls may include a combination, such as a control on the aggregate spending amount at a particular merchant. The processing server 102 may be configured to store transaction data for a transaction account for use in automatically generating transaction controls applicable to multiple transactions.

Once transaction controls have been automatically generated, the processing server 102 may electronically transmit a data signal to the computing device 106 that is superimposed with the generated transaction controls. The data signal may be electronically transmitted using a suitable communication network and method, and may be sent to the computing device 106 indicated in the contact information provided by the consumer 104 during registration and stored in the account profile associated with the transaction account used in the payment transaction. The computing device 106 may display the transaction controls to the consumer 104. The consumer 104 may then select (e.g., via a suitable input device of the computing device 106) one or more transaction controls that they would like to save for future use, based on the declined transaction. The computing device 106 may electronically transmit a data signal back to the processing server 102 using a suitable communication network that is superimposed with the consumer's selection of transaction controls to save. The processing server 102 may then update the account profile to include the indicated transaction controls. Those transaction controls may then be used in the determination of approval or denial of future payment transactions conducted using the transaction account.

The use of an authorization request for a declined payment transaction to automatically generate transaction controls may result in the generation of transaction controls that are more accurate to a consumer's spending behaviors, and may do so more quickly and with significantly higher efficiency than may be done by the consumer 104 using traditional systems. In addition, because the transaction controls are automatically generated by the processing server 102, the transaction controls may be established with significantly less participation by the consumer 104, resulting in faster generation of transaction controls that is significantly more convenient to the consumer 104. As a result, consumers may have higher account security than in traditional control schemes, and with less participation due to the technological improvements of the processing server 102 discussed herein.

### Processing Server

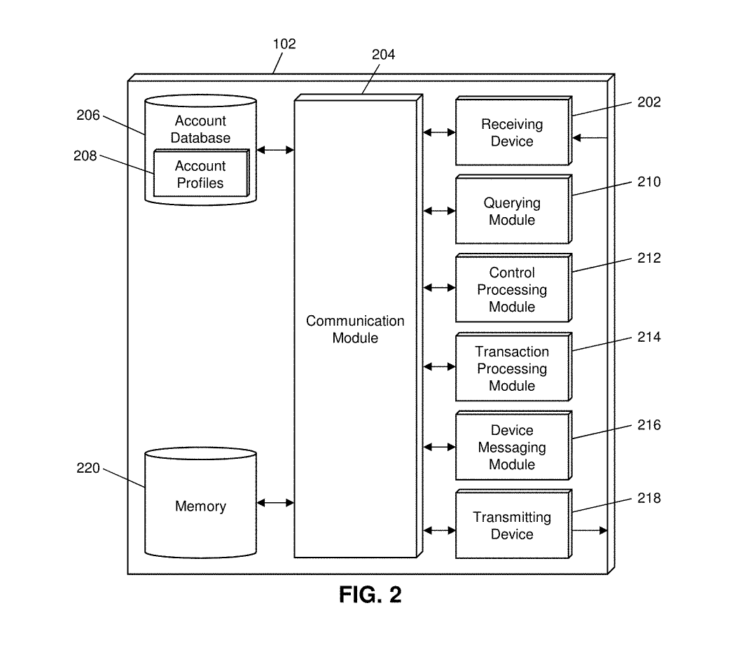

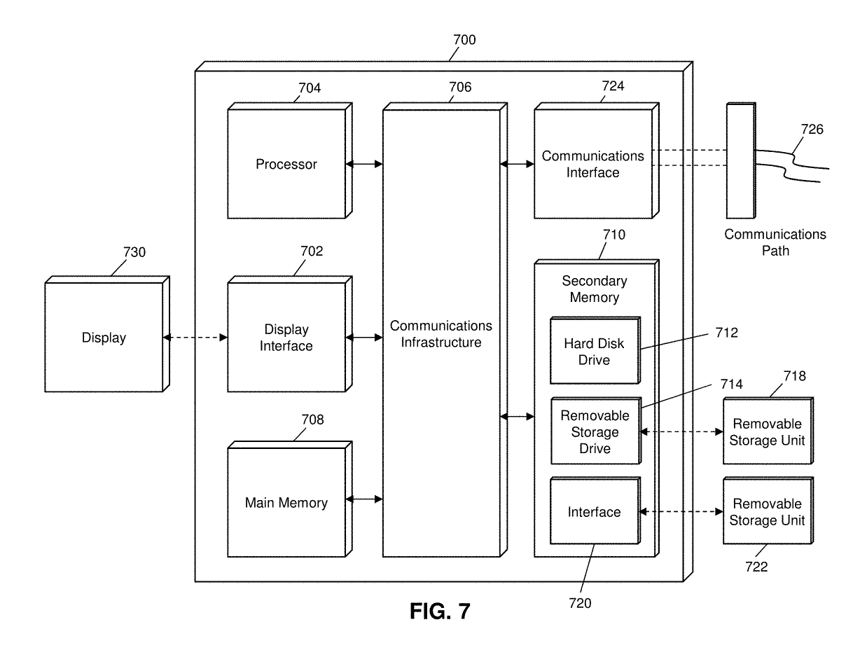

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 110 for the transmission of transaction messages that include sensitive financial data and information. In some instances, the receiving device 202 may also be configured to receive data from computing devices 106, merchant systems 108, payment networks 110, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by the computing device 106. The receiving device 202 may receive data signals electronically transmitted by the computing device 106 superimposed with registration information, such as to register a transaction account for control, or with transaction control selections, such as to indicate one or more automatically generated transaction controls for future use. Additional data signals may be received from the computing device 106, such as data signals superimposed with additional instructions and actions related to account management, such as the manual addition, revision, and removal of transaction controls or registration of additional transaction accounts for shared or additional transaction controls. The receiving device 202 may also be configured to receive transaction messages, such as may be received via the payment rails from the payment network 110 or a merchant system 108 (e.g., as transmitted via one or more intermediate entities). Transaction messages may be formatted pursuant to one or more standards, such as the ISO 8583 standard, and include a plurality of data elements, including at least a first data element configured to store a primary account number and a plurality of additional data elements configured to store transaction data.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc., as well as being configured to establish communication channels with outside systems and devices, such as the electronic point of sale device 104. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, control processing module 212, transaction processing module 214, device processing module 216, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include a memory 220. The memory 220 may be configured to store data for use by the processing server 102 in performing the functions discussed herein. The memory 220 may be configured to store data using suitable data formatting methods and schema and may be any suitable type of memory, such as read-only memory, random access memory, etc. The memory 220 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. The memory 220 may also include or be comprised of a relational database that utilizes structured query language for the storage, identification, modifying, updating, accessing, etc. of structured data sets stored therein.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data associated with a transaction account. Each account profile 208 may include at least a primary account number (e.g., controlled payment number) corresponding to the related transaction account, communication data for use in communicating with an associated consumer 104 (e.g., via one or more computing devices 106), and one or more transaction controls. Each transaction control may be set to control usage of the related transaction account in the funding of an electronic payment transaction, such that transactions involving the related transaction account are denied if each transaction control is not satisfied. Data stored in each account profile 208 may be received by the receiving device 202 in the registration process and via account management by the related consumer 104, as well as include transaction controls automatically generated by the processing server 102.

The processing server 102 may also include a querying module 210. The querying module 210 may be configured to execute queries on databases to identify information. The querying module 210 may receive one or more data values or query strings, and may execute a query string based thereon on an indicated database, such as the account database 206, to identify information stored therein. The querying module 210 may then output the identified information to an appropriate engine or module of the processing server 102 as necessary. The querying module 210 may, for example, execute a query on the account database 206 to identify a specific account profile 208 that is associated with a transaction message received by the receiving device 202. The specific account profile 208 may be identified as an account profile 208 where the included primary account number corresponds to the primary account number stored in the first data element included in a received transaction message.

The processing server 102 may also include a control processing module 212. The control processing module 212 may be configured to automatically generate transaction controls for an electronic payment transaction. The control processing module 212 may receive at least a transaction message and/or data included therein (e.g., stored in the additional data elements) as input, may generate one or more transaction controls, and may output the one or more transaction controls to another module or engine of the processing server 102. In some instances, the control processing module 212 may also receive at least the transaction controls stored in an account profile 208 associated with the transaction message (e.g., as identified using the querying module 210), such as instances where the control processing module 212 may take into account existing transaction controls or past payment transactions. The control processing module 212 may be configured to generate transaction controls that include controls for future payment transactions based on data values stored in the additional data elements included in a received transaction message. In some instances, the control processing module 212 may generate multiple transaction controls from a single transaction message. Transaction controls may be based on a single data value and may be a control on a single data element in future transactions, or may be based on and/or control multiple data values and corresponding data elements in future transactions.

The processing server 102 may also include a transaction processing module 214. The transaction processing module 214 may be configured to perform additional functions of the processing server 102 suitable for use in the processing of payment transactions. For example, the transaction processing module 214 may be configured to calculate fraud scores, perform data checks, and perform additional functions related to value-added services for payment transactions. Additional functions that may be performed by the transaction processing module 212 in conjunction with the initiation and processing of payment transactions will be apparent to persons having skill in the relevant art. In some embodiments, the transaction processing module 214 may also be configured to determine if a payment transaction is to be declined based on transaction controls. In such embodiments, the transaction processing module 214 may receive a transaction message and an account profile 208 or transaction controls included therein for a transaction account involved in the transaction message (e.g., as identified by the querying module 210 using the primary account number). The transaction processing module 214 may then determine if the transaction is to be denied for failing to satisfy at least one of the transaction controls, based on the transaction control and the data values stored in any corresponding data elements included in the transaction message.

If a transaction is to be declined, the transaction processing module 214 may generate a response message. The response message may be an independently generated transaction message based on the received transaction message, or may be a modified version of the transaction message. The response message may include the data elements included in the received transaction message, as well as a second data element configured to store a response code, where the response code indicates that the transaction is declined. In some instances, the response code may indicate that the transaction is declined for failing to comply with transaction controls associated with the transaction account involved in the payment transaction.

The processing server 102 may also include a transmitting device 218. The transmitting device 218 may be configured to transmit data over one or more networks via one or more network protocols. In some embodiments, the transmitting device 218 may be configured to transmit data over the payment rails, such as using specially configured infrastructure associated with payment networks 110 for the transmission of transaction messages that include sensitive financial data and information, such as identified payment credentials. In some instances, the transmitting device 218 may be configured to transmit data to computing devices 106, merchant systems 108, payment networks 110, and other entities via alternative networks, such as the Internet. In some embodiments, the transmitting device 218 may be comprised of multiple devices, such as different transmitting devices for transmitting data over different networks, such as a first transmitting device for transmitting data over the payment rails and a second transmitting device for transmitting data over the Internet. The transmitting device 218 may electronically transmit data signals that have data superimposed that may be parsed by a receiving computing device. In some instances, the transmitting device 218 may include one or more modules for superimposing, encoding, or otherwise formatting data into data signals suitable for transmission.

The transmitting device 214 may be configured to electronically transmit data signals to the payment network 110 and/or merchant system 108 via the payment rails. Data signals transmitted to the payment network 110 and/or merchant system 108 may include transaction messages, such as response transaction messages, which may be used in the processing of a related payment transaction. The transmitting device 214 may also be configured to electronically transmit data signals to the computing device 106 using a suitable communication method and protocol, such as data signals superimposed with automatically generated transaction controls and other data used in the management of a consumer's account registered with the processing server 102.

In some embodiments, the processing server 102 may include a device messaging module 216. The device messaging module 216 may be configured to electronically transmit data signals to the computing device 106 in place of the transmitting device 218, or in conjunction with the transmitting device 218. The device messaging module 216 may be configured to generate the data messages for transmission to the computing device 106 based on the associated communication method and any associated protocols and standards. The device messaging module 216 may generate a data message, such as one that includes a plurality of automatically generated transaction controls, in a manner requested by the consumer 104 corresponding to the computing device 106 as specified during registration of the associated transaction account.

### Process for Automatic Generation of Transaction Controls

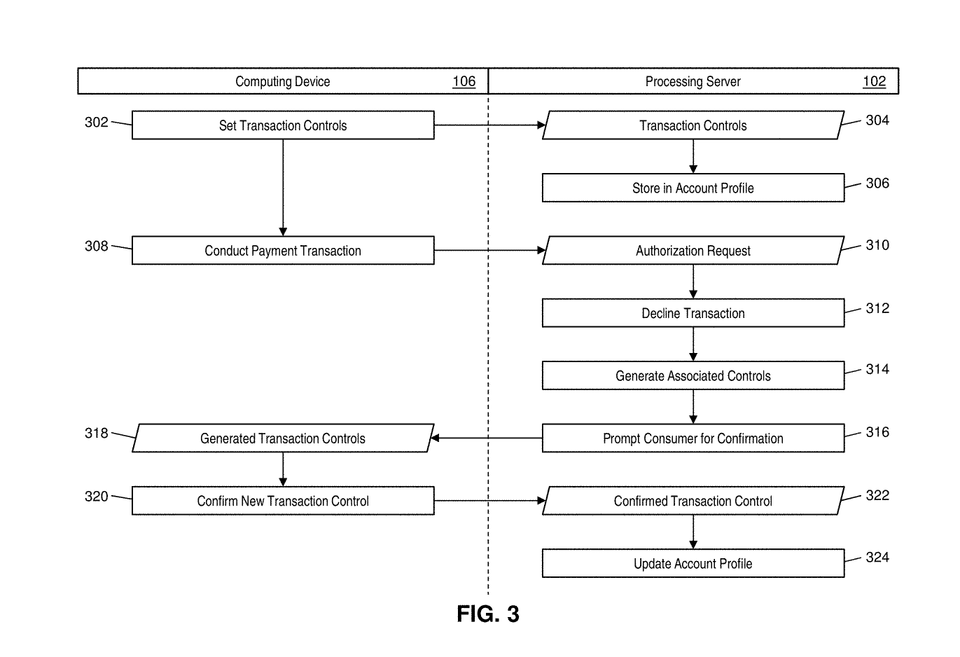

FIG. 3 illustrates a process for the automatic generation of transaction controls based on a declined transaction and implementation thereof in an account profile upon consumer acceptance.

In step 302, the consumer 104 may set one or more transaction controls for a registered transaction account using the computing device 106. As part of the setting of the transaction controls, the computing device 106 may electronically transmit a data signal superimposed with the transaction controls and account identifying information to the processing server 102 via a suitable communication network. The account identifying information may include information suitable for use in identifying the related account profile 208, such as an identification number, username, e-mail address, telephone number, device identifier, primary account number, etc. In step 304, the receiving device 202 of the processing server 102 may receive the transaction controls and account identifier. In step 306, the querying module 210 of the processing server 102 may execute a query on the account database 206 to store the received transaction controls in the account profile 208 that includes the account identifier.

In step 308, the computing device 106 may be used to conduct a payment transaction with a merchant system 108. In some embodiments, the consumer 104 associated with the computing device 106 may conduct the payment transaction without use of the computing device 106 directly, such as by presenting the payment instrument 107 associated with the registered transaction account to the merchant system 108. As part of the conducting of the payment transaction, in step 310, the receiving device 202 of the processing server 102 may receive an authorization request for the payment transaction. The authorization request may be a transaction message formatted based on one or more standards, such as the ISO 8583 standard, that includes at least a first data element configured to store a primary account number associated with the registered transaction account, one or more additional data elements configured to store transaction data, and a message type indicator indicative of an authorization request.

In step 312, the transaction processing module 214 of the processing server 102 may decline the payment transaction. The transaction processing module 214 may instruct the querying module 210 to execute a query on the account database 206 to identify an account profile 208 associated with the transaction that includes the primary account number stored in the first data element included in the transaction message, and may determine that the payment transaction is to be declined based on the transaction controls included in the account profile 208 as compared to the transaction data stored in the one or more additional data elements included in the transaction message. The transaction may be declined if the transaction is not in compliant with the transaction controls, based on the data values of the additional data elements in the transaction message. In step 314, the control processing module 212 of the processing server 102 may automatically generate one or more transaction controls associated with the payment transaction. The transaction controls may be generated based on the data values stored in the one or more additional data elements.

In step 316, the device messaging module 216 of the processing server 102 may generate a data message that includes at least the generated transaction controls and the transmitting device 218 of the processing server 102 may electronically transmit a data signal superimposed with the data message to the computing device 106 using a suitable communication network to prompt the consumer 104 to confirm new transaction controls. In step 318, the computing device 106 may receive the data message that includes the automatically generated transaction controls, which may be displayed to the consumer 104 associated therewith using a suitable display device. In step 320, the consumer 104 may input their confirmation of one or more new transaction controls to be added using a suitable input device of the computing device 106, which may then electronically transmit a data signal superimposed with the consumer's selection to the processing server 102 using a suitable communication method.

In step 322, the receiving device 202 of the processing server 102 may receive the data signal superimposed with the consumer's selection. In step 324, the querying module 210 of the processing server 102 may execute a query on the account profile 208 identified for the payment transaction to insert the selected transaction controls in the account profile 208, for use in future payment transactions. In some instances, the insertion of a new transaction control may include the deletion and/or modification of one or more pre-existing transaction controls. For example, the payment transaction may be declined due to having too high of a transaction amount, while transaction controls may not prohibit transactions with a lower transaction amount. The consumer 104 may agree to transaction control enabling transactions having the higher transaction amount, which may be implemented via a new transaction control and deletion of the prior controls, or modification to prior controls to account for a higher transaction amount.

### Graphical User Interface

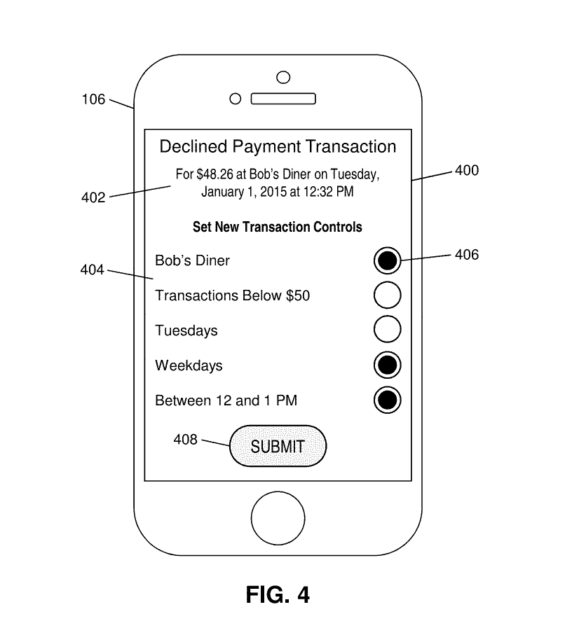

FIG. 4 illustrates a graphical user interface of the computing device 106 for use by the consumer 104 in selecting one or more automatically generated transaction controls to be applied to a transaction account for use in future payment transactions.

The computing device 106 may include a combined display and input device 400. The device 400 may be configured to display data to a user of the computing device 106, such as the consumer 104, and receive input from the user. The device 400 may be, for example, a capacitive touch screen display. The computing device 106 may receive a data signal from the processing server 102 superimposed with automatically generated transaction controls that are generated by the processing server 102 (e.g., by the control processing module 212) upon decline of a payment transaction due to existing transaction controls.

The device 400 may be configured to display data received from the processing server 102. The data may include transaction data 402, which may include data values parsed from the additional data elements included in the transaction message for the payment transaction, which may be used by the consumer 104 in identification of the transaction and comparison to the automatically generated transaction controls. As illustrated in FIG. 4, the transaction data 402 may include the transaction amount, merchant name, transaction date, and transaction time for the payment transaction.

The device 400 may also display a plurality of transaction controls 404. Each transaction control 404 may be an automatically generated transaction control generated by the processing server 102, which may be parsed for display to the consumer 104 on the device 400, such as using one or more rules and/or algorithms of an application program configured for use by the computing device 106 in displaying transaction controls to the consumer 104. In the example illustrated in FIG. 4, the transaction controls 404 may include controls to allow (e.g., or prohibit, as may be indicated by the device 400) transactions at the merchant, below a specific transaction amount, on a specific day or days of the week, and during a specific time period.

The consumer 104 may make selections 406 for each transaction control 404 using the device 400. Each selection 406 may indicate if the consumer 104 desires the corresponding transaction controls to be added. In some embodiments, each transaction control 404 displayed to the consumer 104 may be added as an independent transaction control in the corresponding account profile 208. In other embodiments, a single, combined transaction control may be established. For instance, in the example illustrated in FIG. 4, a transaction control may be stored in the account profile 208 to only allow transactions at Bob's Diner on weekdays between 12 and 1 PM, based on the consumer's selections 406.

The device 400 may also display a submit button 408. When the submit button 408 is interacted with by the consumer 104, the computing device 106 may electronically transmit a data signal to the processing server 102 that includes the selections 406 made by the consumer 104. The processing server 102 may then update the transaction controls for the associated account profile 208 accordingly. For instance, in the illustrated example, the processing server 102 would add a transaction control allowing transactions at Bob's Diner on weekdays between 12 and 1 PM, without a limit on the transaction amount. In such an instance, other transaction controls for the account profile 208 may still limit the transaction amount or otherwise prevent transactions at Bob's Diner between 12 and 1 PM on weekdays, such as a control on the aggregate number of transactions during a period of time.

### Exemplary Method for Automatic Generation of Transaction Controls

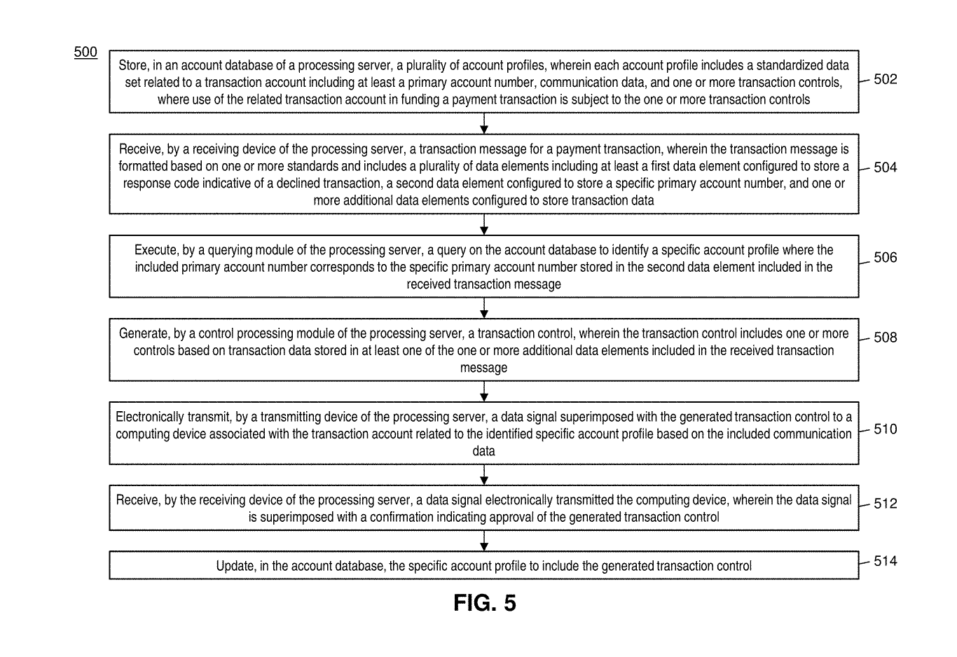

FIG. 5 illustrates a method 500 for the automatic generation of transaction controls for a transaction account based on data values of a declined payment transaction.

In step 502, a plurality of account profiles (e.g., account profiles 208) may be stored in an account database (e.g., the account database 206) of a processing server (e.g., the processing server 102), wherein each account profile includes a standardized data set related to a transaction account including at least a primary account number, communication data, and one or more transaction controls, where use of the related transaction account in funding a payment transaction is subject to the one or more transaction controls. In step 504, a transaction message may be received by a receiving device (e.g., the receiving device 202) of the processing server for a payment transaction, wherein the transaction message is formatted based on one or more standards and includes a plurality of data elements including at least a first data element configured to store a response code indicative of a declined transaction, a second data element configured to store a specific primary account number, and one or more additional data elements configured to store transaction data.

In step 506, a query may be executed on the account database by a querying module (e.g., the querying module 210) of the processing server to identify a specific account profile where the included primary account number corresponds to the specific primary account number stored in the second data element included in the received transaction message. In step 508, a transaction control may be generated by a control processing module (e.g., the control processing module 212) of the processing device, wherein the transaction control includes one or more controls based on transaction data stored in at least one of the one or more additional data elements included in the received transaction message.

In step 510, a data signal superimposed with the generated transaction control may be electronically transmitted by a transmitting device (e.g., the transmitting device 218) of the processing server to a computing device (e.g., the computing device 106) associated with the transaction account related to the identified specific account profile based on the included communication data. In step 512, a data signal electronically transmitted by the computing device may be received by the receiving device, wherein the data signal is superimposed with a confirmation indicating approval of the generated transaction control. In step 514, the specific account profile may be updated in the account database to include the generated transaction control.

In one embodiment, updating the specific account profile may include executing, by the querying module of the processing server, a query on the account database to insert the generated transaction control into the specific account profile. In some embodiments, the response code stored in the first data element included in the received transaction message may indicate denial of the payment transaction due to the one or more transaction controls included in the identified specific account profile. In one embodiment, the transaction message may further include a message type indicator indicative of an authorization response.

In some embodiments, the primary account number may be a controlled payment number. In one embodiment, the communication data may include at least communication network and/or protocol and a communication address. In a further embodiment, the communication address may be at least one of: an e-mail address, telephone number, username, internet protocol address, media access control address, serial number, registration number, and identification number.

In some embodiment, the one or more controls may include a control on at least one of: transaction amount, merchant name, merchant identifier, geographic location, product name, product identifier, product quantity, tax amount, merchant category code, acquirer identifier, issuer identifier, transaction type, transaction time, transaction date, and point of sale identifier. In one embodiment, the method 500 may further include: receiving, by the receiving device of the processing server, a primary transaction message, wherein the primary transaction message is formatted based on the one or more standards and includes at least a message type indicator indicative of an authorization request and a plurality of data elements including a second data element configured to store the specific primary account number and one or more additional data elements configured to store transaction data; and determining, by a transaction processing module (e.g., the transaction processing module 214) of the processing device, non-compliance of the primary transaction message with the one or more transaction controls included in the specific account profile based on at least the transaction data stored in the one or more additional data elements included in the primary transaction message. In a further embodiment, the method 500 may even further include modifying, by the transaction processing module of the processing device, the primary transaction message to store a response code in a first data element included in the primary transaction message indicative of a declined transaction and to update the message type indicator to be indicative of an authorization response, wherein the received transaction message is the modified primary transaction message, and the received transaction message is received by the receiving device from the transaction processing module.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the processing server 102, consumer 104, computing device 106, payment instrument 107, merchant system 108, payment network 110, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3 and 5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 6663 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 6663 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, the merchant 606 may then provide the products purchased by the consumer 604 as part of the payment transaction to the consumer 604, assuming the payment transaction is approved.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 612. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3, 5, and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3, 5, and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for automatic generation of transaction controls. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automatic generation of transaction controls, comprising:
storing, in an account database of a processing server, a plurality of account profiles, wherein each account profile includes a standardized data set related to a transaction account including at least a primary account number, communication data, and one or more transaction controls, where use of the related transaction account in funding a payment transaction is subject to the one or more transaction controls;
receiving, by a receiving device of the processing server, a transaction message for a payment transaction, wherein the transaction message is formatted based on one or more standards and includes a plurality of data elements including at least a first data element configured to store a response code indicative of a declined transaction, a second data element configured to store a specific primary account number, and one or more additional data elements configured to store transaction data;
executing, by a querying module of the processing server, a query on the account database to identify a specific account profile where the included primary account number corresponds to the specific primary account number stored in the second data element included in the received transaction message;
generating, by a control processing module of the processing server, a transaction control, wherein the transaction control includes one or more controls based on transaction data stored in at least one of the one or more additional data elements included in the received transaction message;
electronically transmitting, by a transmitting device of the processing server, a data signal superimposed with the generated transaction control to a computing device associated with the transaction account related to the identified specific account profile based on the included communication data;
receiving, by the receiving device of the processing server, a data signal electronically transmitted the computing device, wherein the data signal is superimposed with a confirmation indicating approval of the generated transaction control; and
updating, in the account database, the specific account profile to include the generated transaction control.

2. The method of claim 1, wherein updating the specific account profile includes executing, by the querying module of the processing server, a query on the account database to insert the generated transaction control into the specific account profile.

3. The method of claim 1, wherein the response code stored in the first data element included in the received transaction message indicates denial of the payment transaction due to the one or more transaction controls included in the identified specific account profile.

4. The method of claim 1, wherein the transaction message further includes a message type indicator indicative of an authorization response.

5. The method of claim 1, wherein the primary account number is a controlled payment number.

6. The method of claim 1, wherein the communication data includes at least communication network and/or protocol and a communication address.

7. The method of claim 6, wherein the communication address is at least one of: an e-mail address, telephone number, username, internet protocol address, media access control address, serial number, registration number, and identification number.

8. The method of claim 1, wherein the one or more controls includes a control on at least one of: transaction amount, merchant name, merchant identifier, geographic location, product name, product identifier, product quantity, tax amount, merchant category code, acquirer identifier, issuer identifier, transaction type, transaction time, transaction date, and point of sale identifier.

9. The method of claim 1, further comprising:
receiving, by the receiving device of the processing server, a primary transaction message, wherein the primary transaction message is formatted based on the one or more standards and includes at least a message type indicator indicative of an authorization request and a plurality of data elements including a second data element configured to store the specific primary account number and one or more additional data elements configured to store transaction data; and
determining, by a transaction processing module of the processing device, non-compliance of the primary transaction message with the one or more transaction controls included in the specific account profile based on at least the transaction data stored in the one or more additional data elements included in the primary transaction message.

10. The method of claim 9, further comprising:
modifying, by the transaction processing module of the processing device, the primary transaction message to store a response code in a first data element included in the primary transaction message indicative of a declined transaction and to update the message type indicator to be indicative of an authorization response, wherein
the received transaction message is the modified primary transaction message, and
the received transaction message is received by the receiving device from the transaction processing module.

11. A system for automatic generation of transaction controls, comprising:
an account database of a processing server configured to store a plurality of account profiles, wherein each account profile includes a standardized data set related to a transaction account including at least a primary account number, communication data, and one or more transaction controls, where use of the related transaction account in funding a payment transaction is subject to the one or more transaction controls;
a receiving device of the processing server configured to receive a transaction message for a payment transaction, wherein the transaction message is formatted based on one or more standards and includes a plurality of data elements including at least a first data element configured to store a response code indicative of a declined transaction, a second data element configured to store a specific primary account number, and one or more additional data elements configured to store transaction data;
a querying module of the processing server configured to execute a query on the account database to identify a specific account profile where the included primary account number corresponds to the specific primary account number stored in the second data element included in the received transaction message;
a control processing module of the processing server configured to generate a transaction control, wherein the transaction control includes one or more controls based on transaction data stored in at least one of the one or more additional data elements included in the received transaction message; and
a transmitting device of the processing server configured to electronically transmit a data signal superimposed with the generated transaction control to a computing device associated with the transaction account related to the identified specific account profile based on the included communication data, wherein
the receiving device of the processing server is further configured to receive a data signal electronically transmitted the computing device, wherein the data signal is superimposed with a confirmation indicating approval of the generated transaction control, and
the processing server is further configured to update, in the account database, the specific account profile to include the generated transaction control.

12. The system of claim 11, wherein updating the specific account profile includes executing, by the querying module of the processing server, a query on the account database to insert the generated transaction control into the specific account profile.

13. The system of claim 11, wherein the response code stored in the first data element included in the received transaction message indicates denial of the payment transaction due to the one or more transaction controls included in the identified specific account profile.

14. The system of claim 11, wherein the transaction message further includes a message type indicator indicative of an authorization response.

15. The system of claim 11, wherein the primary account number is a controlled payment number.

16. The system of claim 11, wherein the communication data includes at least communication network and/or protocol and a communication address.

17. The system of claim 16, wherein the communication address is at least one of: an e-mail address, telephone number, username, internet protocol address, media access control address, serial number, registration number, and identification number.

18. The system of claim 11, wherein the one or more controls includes a control on at least one of: transaction amount, merchant name, merchant identifier, geographic location, product name, product identifier, product quantity, tax amount, merchant category code, acquirer identifier, issuer identifier, transaction type, transaction time, transaction date, and point of sale identifier.

19. The system of claim 11, further comprising:
a transaction processing module of the processing server, wherein
the receiving device of the processing server is further configured to receive a primary transaction message, wherein the primary transaction message is formatted based on the one or more standards and includes at least a message type indicator indicative of an authorization request and a plurality of data elements including a second data element configured to store the specific primary account number and one or more additional data elements configured to store transaction data, and
the transaction processing module of the processing device is configured to determine non-compliance of the primary transaction message with the one or more transaction controls included in the specific account profile based on at least the transaction data stored in the one or more additional data elements included in the primary transaction message.

20. The system of claim 19, wherein
the transaction processing module of the processing device is further configured to modify the primary transaction message to store a response code in a first data element included in the primary transaction message indicative of a declined transaction and to update the message type indicator to be indicative of an authorization response, and
the received transaction message is the modified primary transaction message, and
the received transaction message is received by the receiving device from the transaction processing module.
